(19) United States
(12) Patent Application Publication
(10) Pub. No.: US 2017/0185261 A1
(43) Pub. Date: Jun. 29, 2017

(54) VIRTUAL REALITY DEVICE, METHOD FOR VIRTUAL REALITY

(71) Applicant: HTC Corporation, Taoyuan City (TW)

(72) Inventors: Elbert Stephen Perez, Taoyuan City (TW); Richard Herbert Quay, Taoyuan City (TW); Dennis Todd Harrington, Taoyuan City (TW); Daniel Jeffrey Wilday, Taoyuan City (TW); Weston Page Vierregger, Taoyuan City (TW); David Brinda, Taoyuan City (TW); Andrew Charles Hunt, Taoyuan City (TW); Jason Leopold Lamparty, Taoyuan City (TW); William Brian Espinosa, Taoyuan City (TW); Jonathan D. Faunce, Taoyuan City (TW)

(21) Appl. No.: 15/390,953

(22) Filed: Dec. 27, 2016

Related U.S. Application Data
(60) Provisional application No. 62/272,023, filed on Dec. 28, 2015.
(60) Provisional application No. 62/281,745, filed on Jan. 22, 2016.
(60) Provisional application No. 62/322,767, filed on Apr. 14, 2016.

(51) Int. Cl. G06F 3/0481; G06F 3/0484

(52) U.S. Cl. CPC G06F 3/04815; G06F 3/04817; G06F 3/04845

(57) ABSTRACT

A method for virtual reality (VR) includes sensing a dragging movement of a VR controller during a period that a trigger of the VR controller is triggered, and displaying a plurality of icons of a tool menu in a VR environment corresponding to a dragging trace of the dragging movement of the VR controller.

### RELATED APPLICATIONS

This application claims priority to Provisional U.S. Application Ser. No. 62/272,023 filed Dec. 28, 2015, Provisional U.S. Application Ser. No. 62/281,745 filed Jan. 22, 2016, and Provisional U.S. Application Ser. No. 62/322,767 filed Apr. 14, 2016, which are herein incorporated by reference.

### BACKGROUND

Technical Field

The present disclosure relates to an electronic device and a method. More particularly, the present disclosure relates to a virtual reality device and a method for virtual reality.

Description of Related Art

With advances in electronic technology, virtual reality (VR) systems are being increasingly used.

A VR system may provide a user interface to a user to allow the user to interact with the VR system. Hence, how to design a user friendly interface is an important area of research in this field.

### SUMMARY

One aspect of the present disclosure is related to a method for virtual reality (VR). In accordance with one embodiment of the present disclosure, the method includes sensing a dragging movement of a VR controller during a period that a trigger of the VR controller is triggered, and displaying a plurality of icons of a tool menu in a VR environment corresponding to a dragging trace of the dragging movement of the VR controller.

Another aspect of the present disclosure is related to a virtual reality (VR) device. In accordance with one embodiment of the present disclosure, the VR includes one or more processing components, memory electrically connected to the one or more processing components, and one or more programs. The one or more programs are stored in the memory and configured to be executed by the one or more processing components. The one or more programs comprising instructions for sensing a dragging movement of a VR controller during a period that a trigger of the VR controller is triggered; and controlling a VR display device to display a plurality of icons of a tool menu in a VR environment corresponding to a dragging trace of the dragging movement of the VR controller.

Through the operations of one embodiment described above, displaying positions of the icons of the tool menu can be determined arbitrarily.

### BRIEF DESCRIPTION OF THE DRAWINGS

The invention can be more fully understood by reading the following detailed description of the embodiments, with reference made to the accompanying drawings as follows:

FIG. 1 is a schematic block diagram of a virtual reality (VR) system in accordance with one embodiment of the present disclosure.

FIG. 2 illustrates an illustrative example of the VR system in accordance with one embodiment of the present disclosure.

FIG. 3 illustrates an illustrative example of the VR system in accordance with one embodiment of the present disclosure.

FIG. 4 illustrates an illustrative example of the VR system in accordance with one embodiment of the present disclosure.

FIG. 5 illustrates an illustrative example of the VR system in accordance with one embodiment of the present disclosure.

FIG. 6 illustrates an illustrative example of the VR system in accordance with one embodiment of the present disclosure.

FIG. 7 illustrates an illustrative example of the VR system in accordance with one embodiment of the present disclosure.

FIG. 8 illustrates an illustrative example of the VR system in accordance with one embodiment of the present disclosure.

FIG. 9 illustrates an illustrative example of the VR system in accordance with one embodiment of the present disclosure.

FIG. 10 illustrates an illustrative example of the VR system in accordance with one embodiment of the present disclosure.

FIG. 11 illustrates an illustrative example of the VR system in accordance with one embodiment of the present disclosure.

FIG. 12 illustrates an illustrative example of the VR system in accordance with one embodiment of the present disclosure.

FIG. 13 illustrates an illustrative example of the VR system in accordance with one embodiment of the present disclosure.

FIG. 14 illustrates an illustrative example of the VR system in accordance with one embodiment of the present disclosure.

FIG. 15 illustrates an illustrative example of the VR system in accordance with one embodiment of the present disclosure.

FIG. 16 illustrates an illustrative example of the VR system in accordance with one embodiment of the present disclosure.

FIG. 17 illustrates an illustrative example of the VR system in accordance with one embodiment of the present disclosure.

FIG. 18 illustrates an illustrative example of the VR system in accordance with one embodiment of the present disclosure.

FIG. 19 illustrates an illustrative example of the VR system in accordance with one embodiment of the present disclosure.

FIG. 20 illustrates an illustrative example of the VR system in accordance with one embodiment of the present disclosure.

FIG. 21 is a flowchart of a method in accordance with one embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

It will be understood that, in the description herein and throughout the claims that follow, when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Moreover, “electrically connect” or “connect” can further refer to the interoperation or interaction between two or more elements.

It will be understood that, in the description herein and throughout the claims that follow, although the terms “first,” “second,” etc. may be used to describe various elements, these elements should not be limited by these terms. These terms are only used to distinguish one element from another. For example, a first element could be termed a second element, and, similarly, a second element could be termed a first element, without departing from the scope of the embodiments.

It will be understood that, in the description herein and throughout the claims that follow, the terms “comprise” or “comprising,” “include” or “including,” “have” or “having,” “contain” or “containing” and the like used herein are to be understood to be open-ended, i.e., to mean including but not limited to.

It will be understood that, in the description herein and throughout the claims that follow, the phrase “and/or” includes any and all combinations of one or more of the associated listed items.

It will be understood that, in the description herein and throughout the claims that follow, words indicating direction used in the description of the following embodiments, such as “above,” “below,” “left,” “right,” “front” and “back,” are directions as they relate to the accompanying drawings. Therefore, such words indicating direction are used for illustration and do not limit the present disclosure.

It will be understood that, in the description herein and throughout the claims that follow, unless otherwise defined, all terms (including technical and scientific terms) have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any element in a claim that does not explicitly state “means for” performing a specified function, or “step for” performing a specific function, is not to be interpreted as a “means” or “step” clause as specified in 35 U.S.C. §112(f). In particular, the use of “step of” in the claims herein is not intended to invoke the provisions of 35 U.S.C. §112(f).

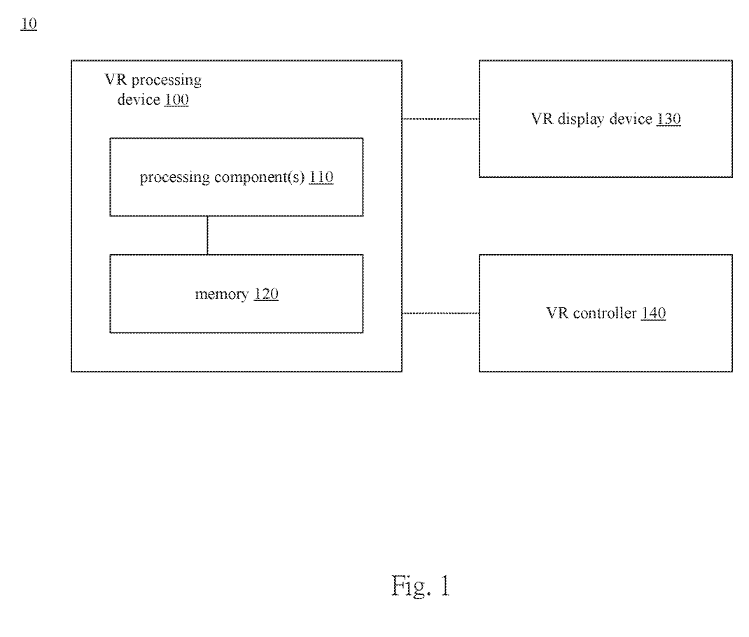

FIG. 1 is a schematic block diagram of a virtual reality (VR) system 10 in accordance with one embodiment of the present disclosure. In this embodiment, the VR system 10 includes a VR processing device 100, a VR display device 130, and a VR controller 140. In one embodiment, the VR processing device 100 may electrically connected to the VR display device 130 and the VR controller 140 via wired or wireless connection. In one embodiment, the VR processing device 100 may be integrated with the VR display device 130 and/or the VR controller 140, and the present disclosure is not limited to the embodiment described herein. In one embodiment, the VR system 10 may include more than one VR controllers.

In one embodiment, the VR system 10 may further includes base stations (not shown) for positioning the VR display device 130 and/or the VR controller 140 and/or detecting tilt angles (e.g., rotating angles) of the VR display device 130 and/or the VR controller 140. However, another positioning method and tilt angle detecting method are within the contemplated scope of the present disclosure.

In one embodiment, the VR processing device 100 includes one or more processing components 110 and a memory 120. In this embodiment, the one or more processing components 110 are electrically connected to the memory 120. In one embodiment, the VR processing device 100 may further include signal transceivers for transmitting and receiving signals between the VR processing device 100 and the VR display device 130 and/or signals between the VR processing device 100 and the VR controller 140.

In one embodiment, the one or more processing components 110 can be realized by, for example, one or more processors, such as central processors and/or microprocessors, but are not limited in this regard. In one embodiment, the memory 120 includes one or more memory devices, each of which comprises, or a plurality of which collectively comprise a computer readable storage medium. The memory 120 may include a read-only memory (ROM), a flash memory, a floppy disk, a hard disk, an optical disc, a flash disk, a flash drive, a tape, a database accessible from a network, or any storage medium with the same functionality that can be contemplated by persons of ordinary skill in the art to which this invention pertains. The VR display device 130 can be realized by, for example, a display, such as a liquid crystal display, or an active matrix organic light emitting display (AMOLED), but is not limited in this regard. The VR controller 140 can be realized by, for example, a handheld controller, such as a controller for Vive or a controller for Gear, but is not limited in this regard.

In one embodiment, the one or more processing components 110 may run or execute various software programs and/or sets of instructions stored in memory 120 to perform various functions for the VR processing device 100 and to process data.

In one embodiment, the one or more processing components 110 can sense movements of the VR controller 140, and control the VR display device 130 to display corresponding to the movements of the VR controller 140.

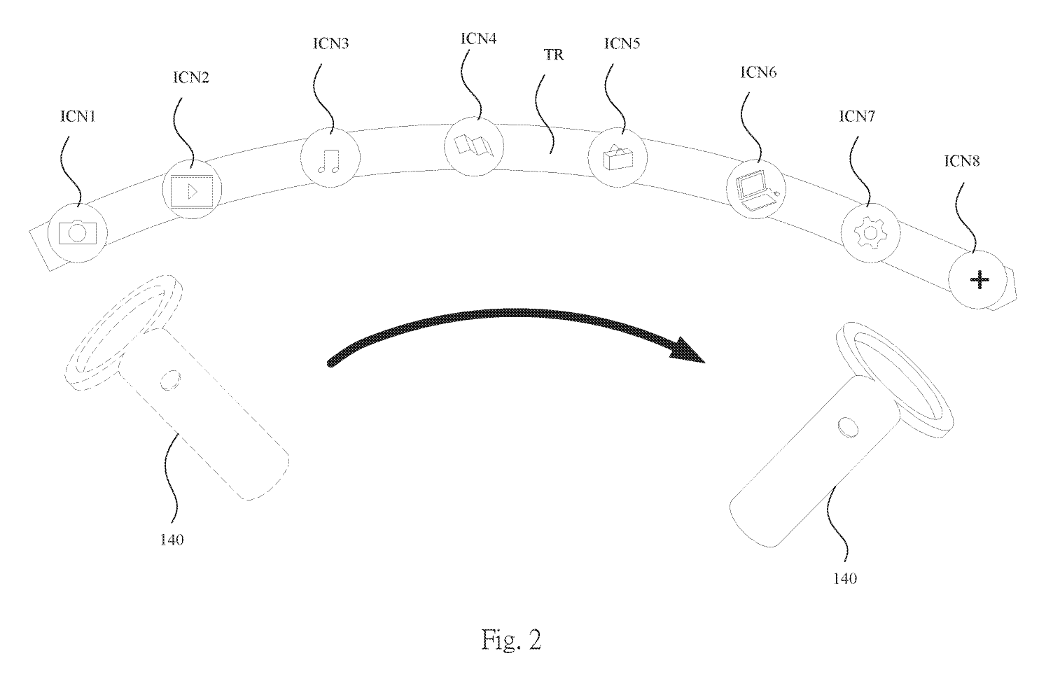

Reference is made to FIG. 2. In one embodiment, under a period that a trigger of the VR controller 140 is triggered, the one or more processing components 110 can sense a dragging movement of the VR controller 140. In one embodiment, the trigger of the VR controller 140 may be a button on the VR controller 140, and the button may be triggered by pressing, but another implementation is within the contemplated scope of the present disclosure.

In one embodiment, in response to the dragging movement of the VR controller 140 is sensed with the trigger of the VR controller 140 being triggered, the one or more processing components 110 can control the VR display device 130 to display a plurality of icons (e.g., icons ICN1-ICN8) of a tool menu in a VR environment corresponding to a dragging trace TR of the dragging movement of the VR controller 140.

In one embodiment, the icons are substantially displayed along with the dragging trace TR. In one embodiment, the icons are displayed sequentially. In one embodiment, the one or more processing components 110 can control the VR controller 140 to provide a haptic feedback corresponding to the displaying of each of the icons of the tool menu (e.g., vibrate while each of the icons appears).

In one embodiment, the icons ICN1-ICN8 correspond to different tools. In one embodiment, the tools may be applications, shortcuts, items, or photographs, and the tools may include icons with functions or icons without functions. For example, in one embodiment, the icon ICN1 may correspond to a camera tool for taking photos. In one embodiment, the icon ICN2 may correspond to a music tool for playing music. In one embodiment, the icon ICN3 may correspond to a video tool for playing videos. In one embodiment, the icon ICN4 may correspond to an artifacts tool for accessing and place artifacts. In one embodiment, the icon ICN5 may correspond to a minimap tool for teleporting across and within a VR space of the VR environment. In one embodiment, the icon ICN6 may correspond to a virtual desktop tool for access applications in a host device (e.g., a PC). In one embodiment, the icon ICN7 may correspond to a setting tool for managing media and other settings in the VR environment. In one embodiment, the icon ICN8 may correspond to an item picker for adding a shortcut into the tool menu to serve as a new icon of the tool menu. It should be noted that the amount and the contents of icons ICN1-ICN8 and the corresponding tools are for illustrative purposes. Another amount and the contents are within the contemplated scope of the present disclosure.

In one embodiment, when one of the icons ICN1-ICN8 is actuated by the VR controller 140 (e.g., the user uses the VR controller 140 to select one of the icons ICN1-ICN8), the one or more processing components 110 may open (e.g., activate) a corresponding tool and control the VR display device 130 to display a corresponding user interface and stop displaying the tool menu (e.g., make the icons disappeared).

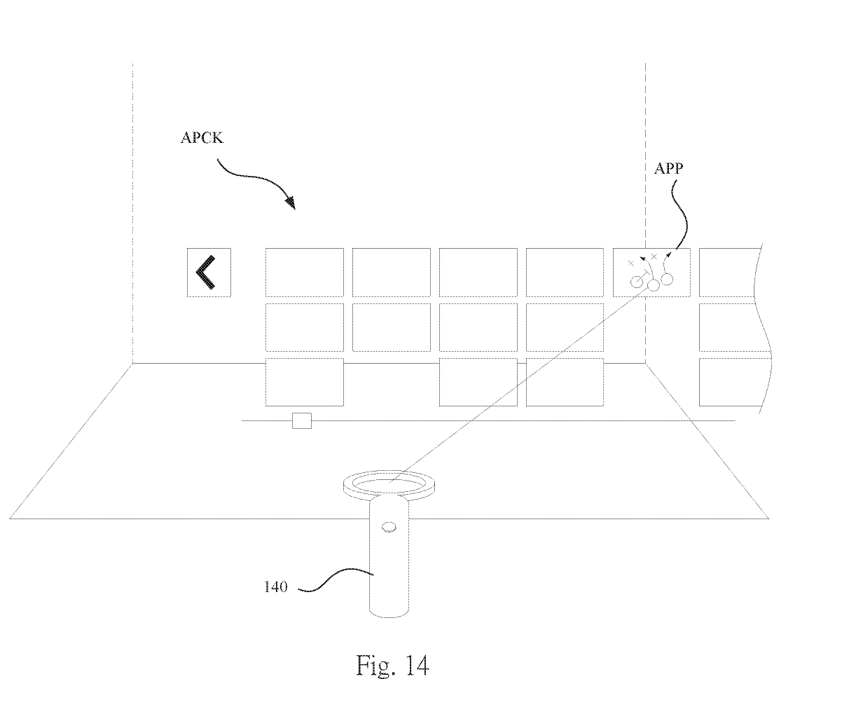

For example, in one embodiment, when the one or more processing components 110 sense an actuation corresponding to the icon ICN8 of the tool menu, the one or more processing components 110 may control the VR display device 130 to display a user interface of an item picker illustrating a plurality images of items (e.g., tools, applications, or artifacts) (e.g., the application picker APCK in FIG. 14) in response to the actuation corresponding to the icon ICN8. Subsequently, when the one or more processing components 110 sense an actuation corresponding to one of the items (e.g., a click on the one of the items or any select way operated by user via the VR controller 140) in the item picker, the one or more processing components 110 add a shortcut of the one of the item into the tool menu to serve as a new icon.

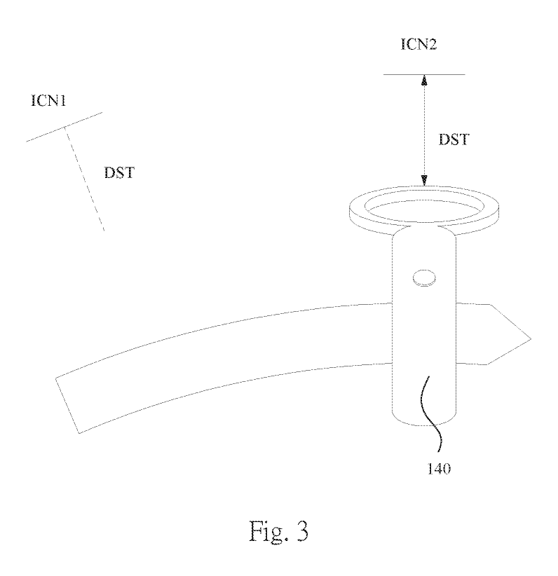

Reference is made to FIG. 3. In one embodiment, in response to the sensation of the dragging movement of the VR controller 140, the one or more processing components 110 can control the VR display device 130 to display each of the icons in front of the VR controller 140 with a distance DST. In one embodiment, the distances DST are identical to or at least partially different from each. In one embodiment, the distance DST may be predetermined. In one embodiment, the distance DST can be adjusted by a user. In one embodiment, the distance DST can be adjusted by using a physical button on the controller 140.

Referring back to FIG. 2, in one embodiment, under a condition that all of the icons of the tool menu are displayed during the period that the trigger of the VR controller 140 is triggered, the icons of the tool menu are displayed substantially along with the dragging trace TR of the dragging movement of the VR controller 140.

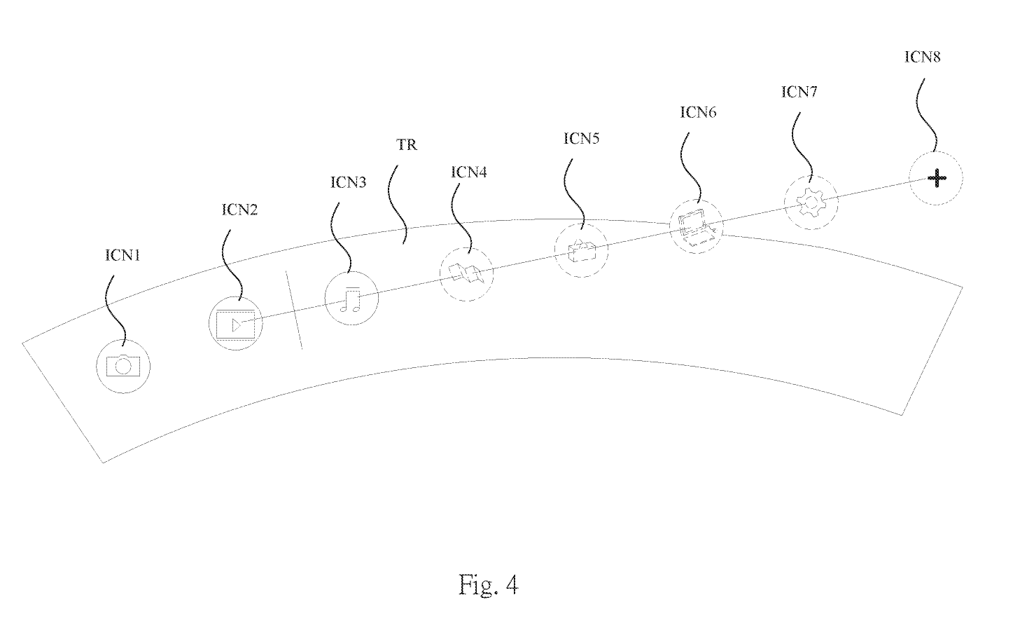

Referring to FIG. 4, in one embodiment, under a condition that the trigger of the VR controller 140 stops being triggered (e.g., the button is released before all of the icons of the tool menu are displayed), and an amount of the displayed icons are greater than a predetermined threshold, the rest icons are displayed according to a vector pointed from the second-to-last displayed icon to the last displayed icon.

For example, under a condition that the predetermined threshold is two, the trigger of the VR controller 140 stops being triggered right after the icon ICN3 appears, the one or more processing components 110 may calculate a vector pointed from the icon ICN2 (i.e., the second-to-last displayed icon) to the icon ICN3 (i.e., the last displayed icon). Subsequently, the one or more processing components 110 control the VR display device 130 to display icons ICN4-ICN8 according to this vector. In one embodiment, the icons ICN4-ICN8 are displayed subsequently or simultaneously. In one embodiment, the icons ICN4-ICN8 are displayed along the vector. In one embodiment, the icons ICN2-ICN8 are displayed on a same straight line.

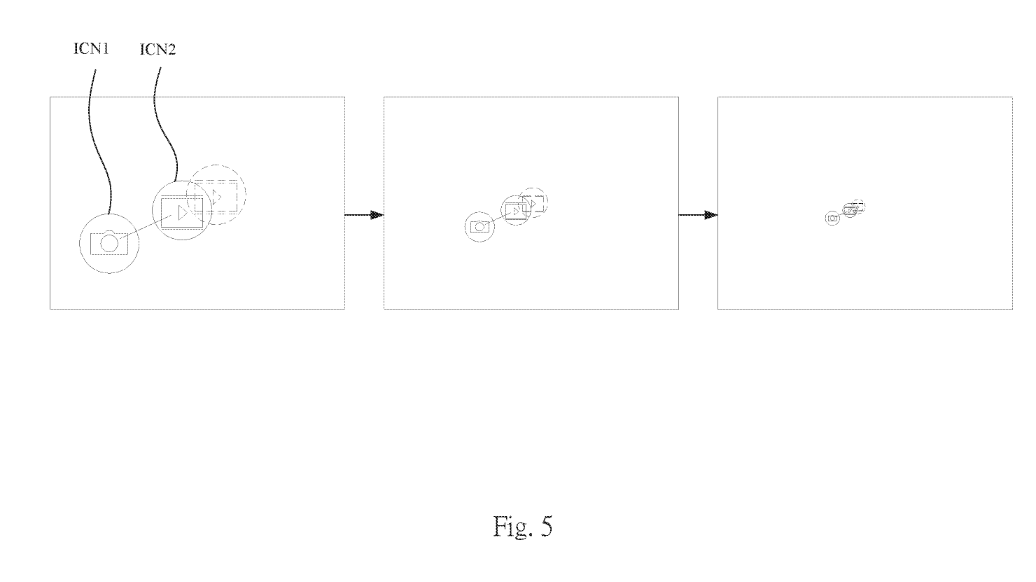

Reference is made to FIG. 5. In one embodiment, under a condition that the trigger of the VR controller 140 stops being triggered (e.g., the button is released) before all of the icons of the tool menu are displayed (e.g., only a part of icons appear), and an amount of the displayed icons are less than or equal to the predetermined threshold, one or multiple displayed icons are shrunk until invisible.

For example, under a condition that the predetermined threshold is two, the trigger of the VR controller 140 stops being triggered right before the icon ICN3 appears, the one or more processing components 110 may control the VR display device 130 to shrink the displayed icons ICN1-ICN2 until they are invisible, so as to make the tool menu collapse.

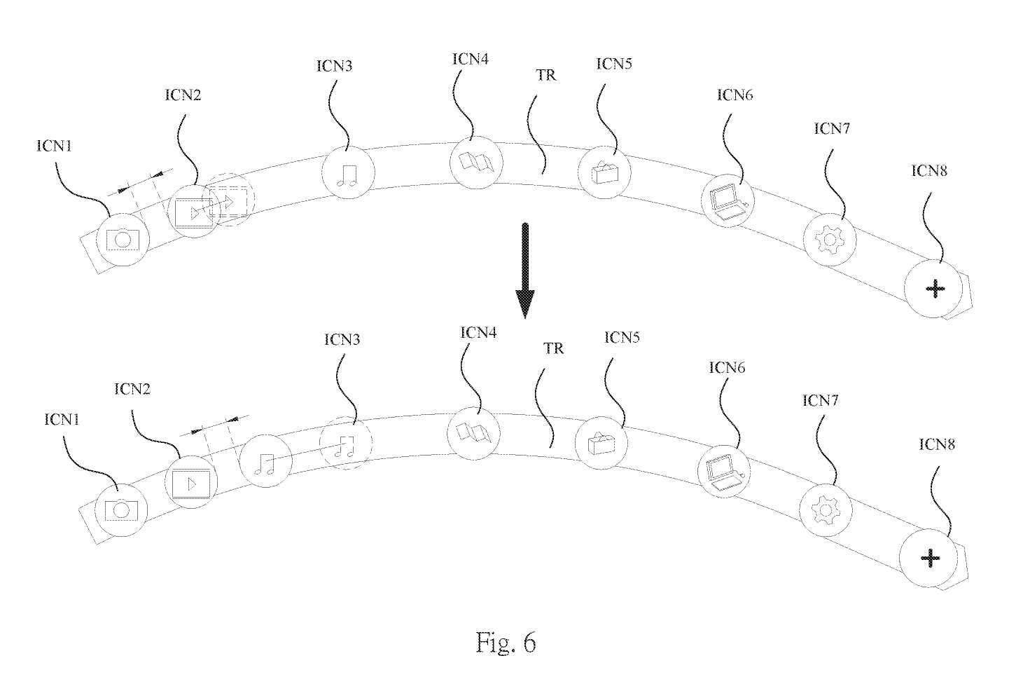

Reference is made to FIG. 6. In one embodiment, after all of the icons are displayed or appear, the icons can spring toward their preceding neighbor, so as to shrink the gaps therebetween.

In one embodiment, the one or more processing components 110 may determine springback positions of the icons of the tool menu. Subsequently, the one or more processing components 110 may control the VR display device 130 to move or animate the icons of the tool menu toward the springback positions. In one embodiment, the distances between original positions of the icons of the tool menu before the icons of the tool menu are animated or moved toward the springback positions are greater than distances between the springback positions of the icons of the tool menu.

In one embodiment, the springback positions can be determined before or after all of the icons are displayed or appear. In one embodiment, the springback positions can be determined corresponding to the dragging trace TR. In one embodiment, the springback positions can be determined substantially along with the dragging trace TR. In one embodiment, the distance between the springback positions of the icons may be identical to or at least partially different from each other. In one embodiment, the icons of the tool menu can be animated or moved toward the springback positions simultaneously. In one embodiment, the springback positions can be determined corresponding to an original position of the first displayed icon.

For example, the springback position of the icon ICN1 may be identical to the original position of the icon ICN1. A springback position of the icon ICN2 may be determined corresponding to the original position of the icon ICN1, in which a distance between the original position of the icon ICN2 and the original position of the icon ICN1 is greater than the distance between the springback position of the icon ICN2 and the springback position of the icon ICN1. A springback position of the icon ICN3 may be determined corresponding to the springback position of the icon ICN2, in which a distance between the original position of the icon ICN3 and the original position of the icon ICN2 is greater than the distance between the springback position of the icon ICN3 and the springback position of the icon ICN2. The rest can be deduced by analogy.

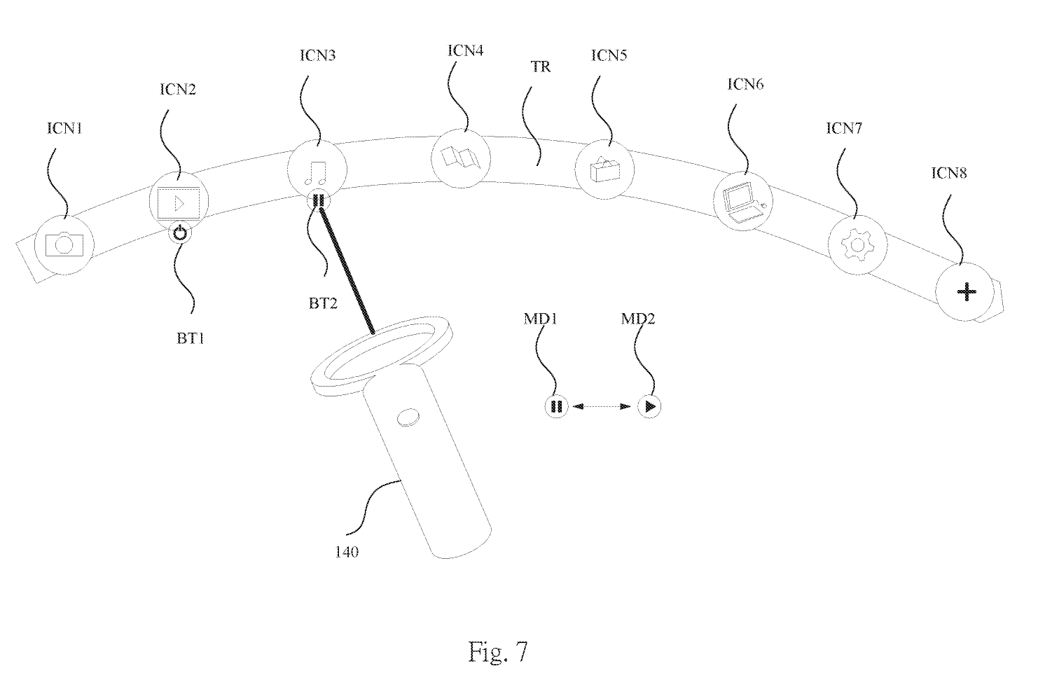

Reference is made to FIG. 7. In one embodiment, the one or more processing components 110 may control the VR display device 130 to display one or more buttons (e.g., buttons BT1-BT2) of a shortcut action corresponding to one or more of the icons of the tool menu. In one embodiment, the buttons of the shortcut action allow a user to access a feature corresponding to the one of the icons of the tool menu without open a tool corresponding to the one of the icons of the tool menu.

In one embodiment, the one or more buttons may also illustrate statuses of corresponding tools. For example, the button BT2 can illustrate that the music tool is under a playing mode or a pause mode by using different graphics MD1, MD2. In this embodiment, when the button BT2 is clicked, the music tool can be switched to a different mode without closing the menu (i.e., make the icons disappear).

In one embodiment, when the one or more processing components 110 sense that the VR controller 140 clicks at anywhere other than the icons, the one or more processing components 110 may control the VR display device 130 to stop displaying the icons of the tool menu.

In one embodiment, when the VR controller 140 is interacting with an artifact, the one or more processing components 110 refrain from controlling the VR display device 130 to display the icons of the tool menu, so as to avoid a drag movement corresponding to the artifact opens the tool menu.

In one embodiment, when a menu of an artifact is opened and the one or more processing components 110 detect the dragging movement of the VR controller 140 with the trigger of the VR controller 140 being triggered, the one or more processing components 110 may dismiss the opened menu and control the VR display device 130 to display the icons of the tool menu.

In one embodiment, after the icons of the tool menu are displayed, if a menu of an artifact is opened, the one or more processing components 110 may dismiss the icons of the tool menu.

In one embodiment, the one or more processing components 110 can sense a hover movement of the VR controller 140 aiming at one of the icons of the tool menu. In response to the hover movement of the VR controller 140 aiming at one of the icons of the tool menu, the one or more processing components 110 can control the VR controller 140 to provide a haptic feedback (e.g., vibrate). In one embodiment, during the process of drawing the icons of the tool menu, the haptic feedback of the hover movement is disabled so as to prevent accidentally triggering two concurrent haptic feedbacks, in which one from displaying the icons of the tool menu, and another from hovering over the icons of the tool menu.

In one embodiment, during the process of drawing the icons of the tool menu, hover/click states for artifacts are prevented until all of the icons of the tool menu have been drawn. In such a manner, accidentally opening a menu of an artifact while drawing the tool menu can be avoided. Additionally, interferences (e.g., flashing or an animation) in the background due to hover events corresponding to the artifacts while drawing the tool menu can also be avoided.

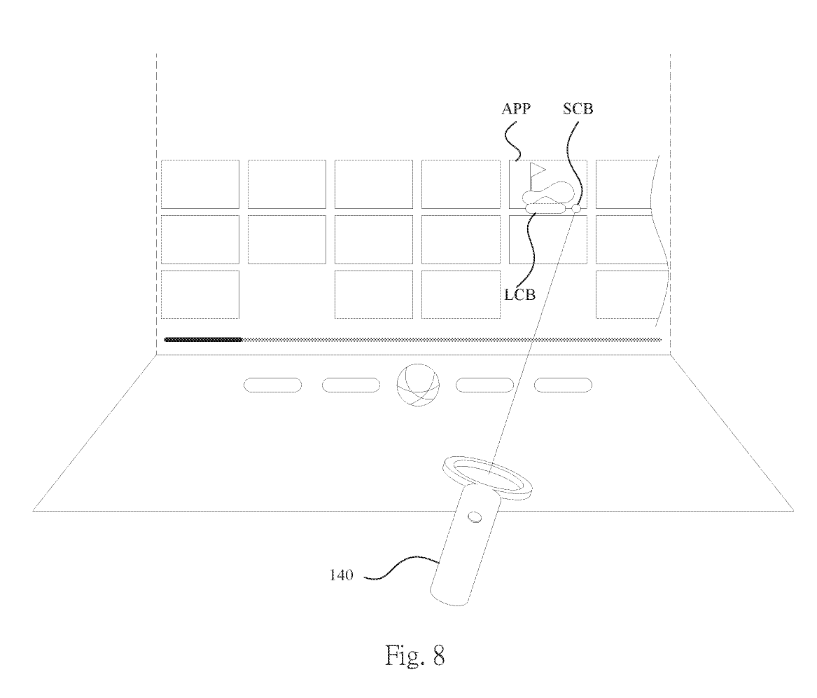

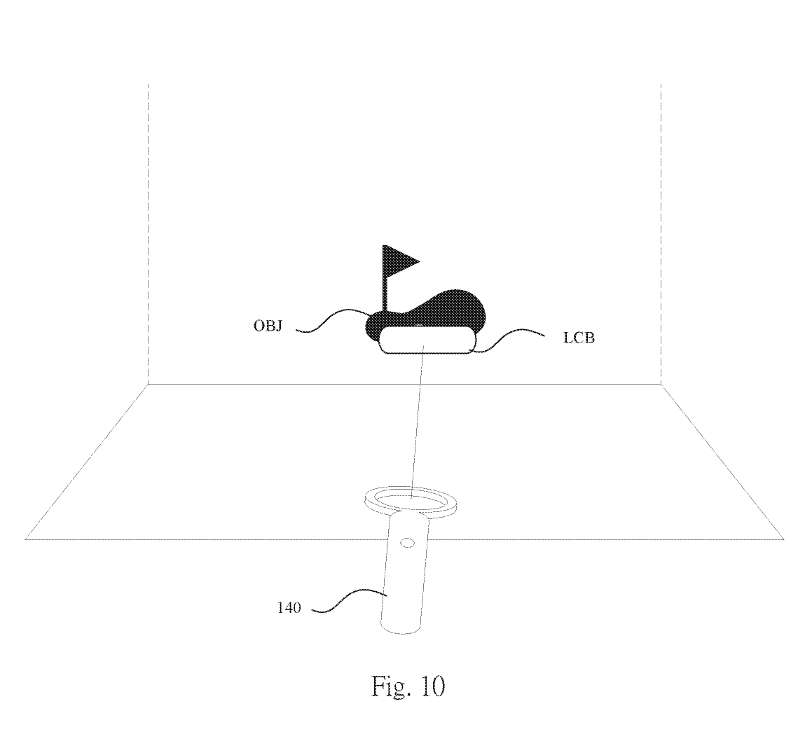

Reference is made to FIGS. 8-10. In one embodiment, the one or more processing components 110 can control the VR display device 130 to display a VR application menu with a plurality of VR applications APP in a VR space. In one embodiment, the one or more processing components 110 can sense a hover movement of the VR controller 140 aiming at one of the VR applications APP. In response to the hover movement of the VR controller 140 aiming at the one of the VR applications APP, the one or more processing components 110 can control the VR display device 130 to display a launch button LCB and a shortcut creating button SCB corresponding to the one of the VR applications APP. In one embodiment, when the VR controller 140 does not aim at the one of the VR applications APP, the one or more processing components 110 can control the VR display device 130 not to display the launch button LCB and the shortcut creating button SCB corresponding to the one of the VR applications APP.

In one embodiment, the one or more processing components 110 can sense an actuating movement (e.g., a click or a selection) of the VR controller 140 on the shortcut creating button SCB. In response to the actuating movement on the shortcut creating button SCB, the one or more processing components 110 can control the VR display device 130 to stop displaying the VR application menu and display a 3D object or an application icon OBJ in the

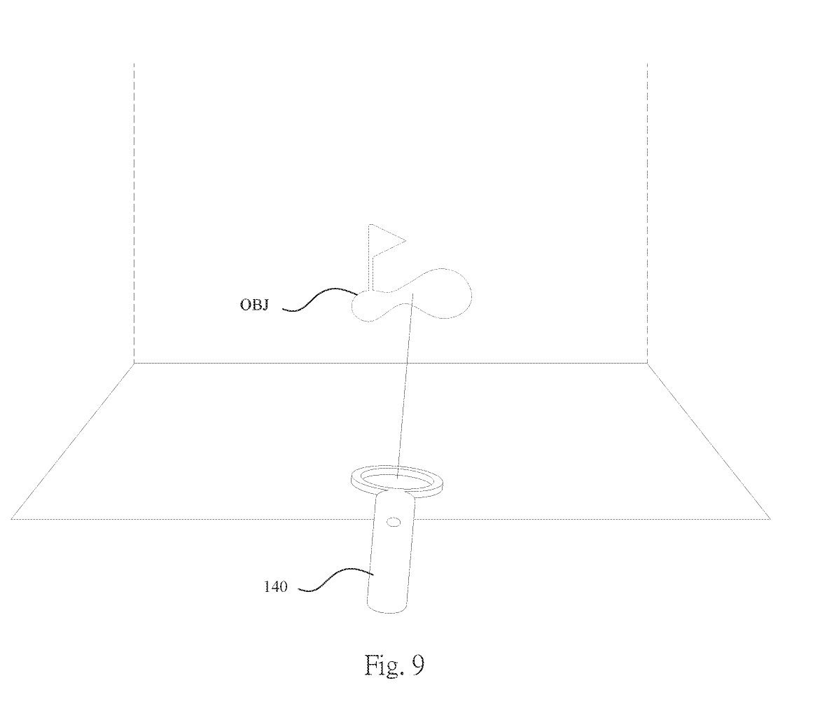

VR space (as illustrated in FIG. 9). In one embodiment, the 3D object or the application icon OBJ is ghostly displayed, and the 3D object or the application icon OBJ can be moved by moving the VR controller 140 around.

Subsequently, in one embodiment, the one or more processing components 110 can sense a pin operation (e.g., a click) of the VR controller 140 corresponding to a certain place. In response to the pin operation of the VR controller 140 corresponding to the certain place, the one or more processing components 110 can place the 3D object or the application icon OBJ at the certain place in the VR space, and control the VR display device 130 to correspondingly display. It should be noted that, in one embodiment, a user may open an application list and selecting one of applications in the list to create a shortcut, and the present disclosure is not limited by the embodiment described above.

In one embodiment, the 3D object or the application icon OBJ may be a shortcut of the one of the VR applications APP. In one embodiment, the one or more processing components 110 can sense a hover movement of the VR controller 140 aiming at the 3D object or the application icon OBJ. In response to the hover movement of the VR controller 140 aiming at the 3D object or the application icon OBJ, the one or more processing components 110 can control the VR display device 130 to display the launch button LCB for launching the corresponding VR application APP. When the corresponding VR applications APP launches, the current VR space will be shut down and a new VR space will open.

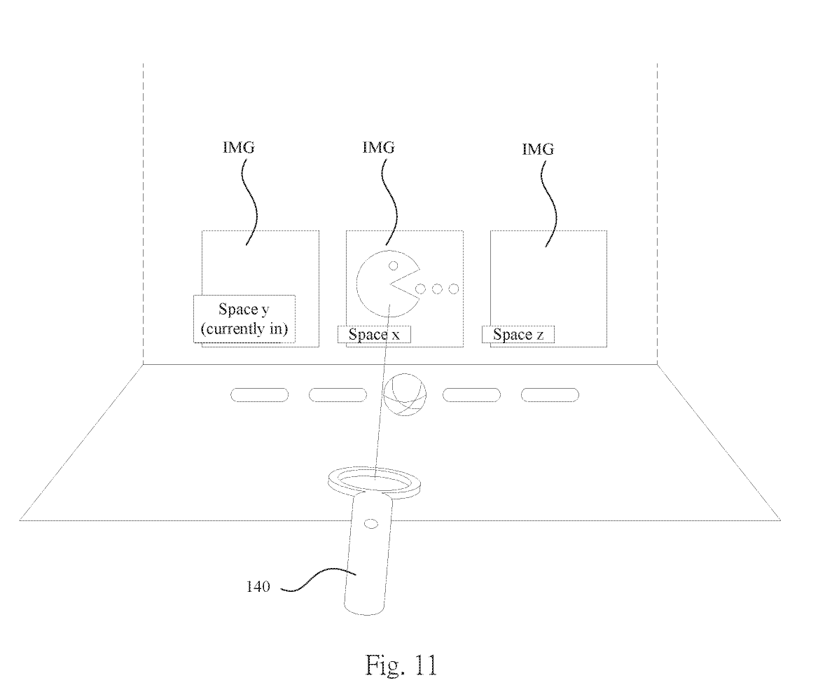

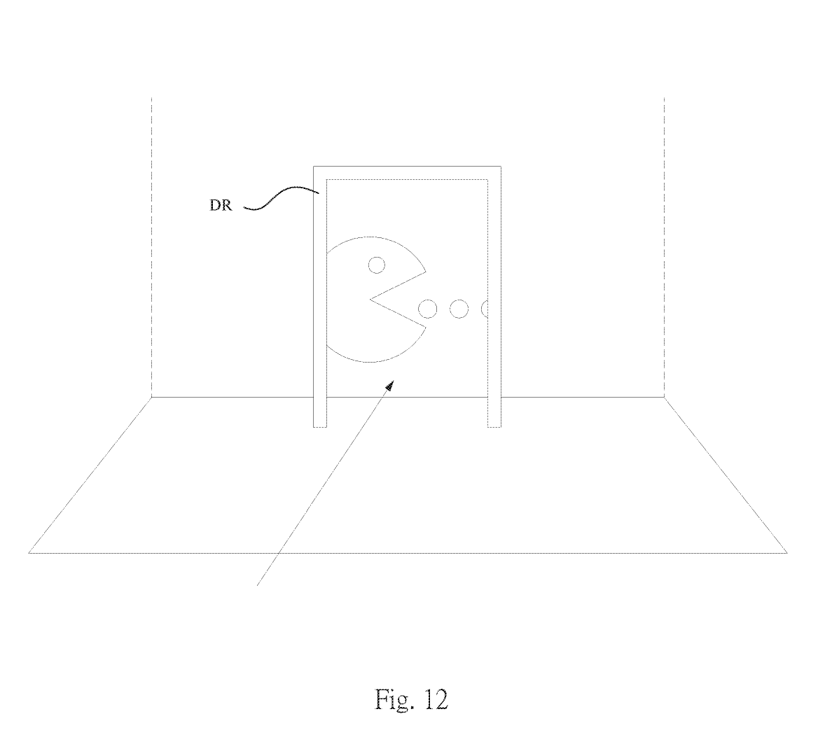

Reference is made to FIGS. 11-12. In one embodiment, the one or more processing components 110 can control the VR display device 130 to display a VR space menu with multiple images respectively corresponding to multiple VR spaces. In one embodiment, the one or more processing components 110 can control the VR display device 130 to show the current space (e.g., space y).

In one embodiment, the one or more processing components 110 can sense an actuating movement (e.g., a click or a selection) of the VR controller 140 on one of the images (e.g., the image corresponding to space x). In response to the actuating movement on the selected image, the one or more processing components 110 can control the VR display device 130 to stop displaying the VR space menu and display a door DR to the selected space (e.g., space x)) corresponding to the selected image. The one or more processing components 110 can also control the VR display device 130 to display the environment and/or the items in the selected space within the contour of the door DR.

In one embodiment, the VR character of the user can walk or teleport through the door DR to enter the selected space. That is, the one or more processing components 110 can sense the walk movement of the user (e.g., according to the position of the VR display device 130) and/or the teleport movement of the VR controller 140 (e.g., a click within the door DR). In response to the walk movement of the user or the teleport movement of the VR controller 140 is sensed, the one or more processing components 110 determine the VR character of the user enter the selected space, and control the VR display device 130 to display the environment of the selected space around the VR character of the user.

In one embodiment, the one or more processing components 110 sense the position of the VR controller 140 corresponding to the door DR. When the VR controller 140 is put through the doorway of the door DR, the one or more processing components 110 can control the VR controller 140 to provide a haptic feedback, as if the user is passing through some kind of force field.

In one embodiment, the one or more processing components 110 can control the VR display device 130 to display a space setting panel. The space setting panel includes a mic mute option for muting a mic, a headphone volume controller for controlling a volume of headphones, a menu volume controller for controlling a volume of menus, a space volume controller for control a volume of a space, an locomotion option for turning on or off the locomotion function, and a bounding option for hiding or showing the outline of the room in real life.

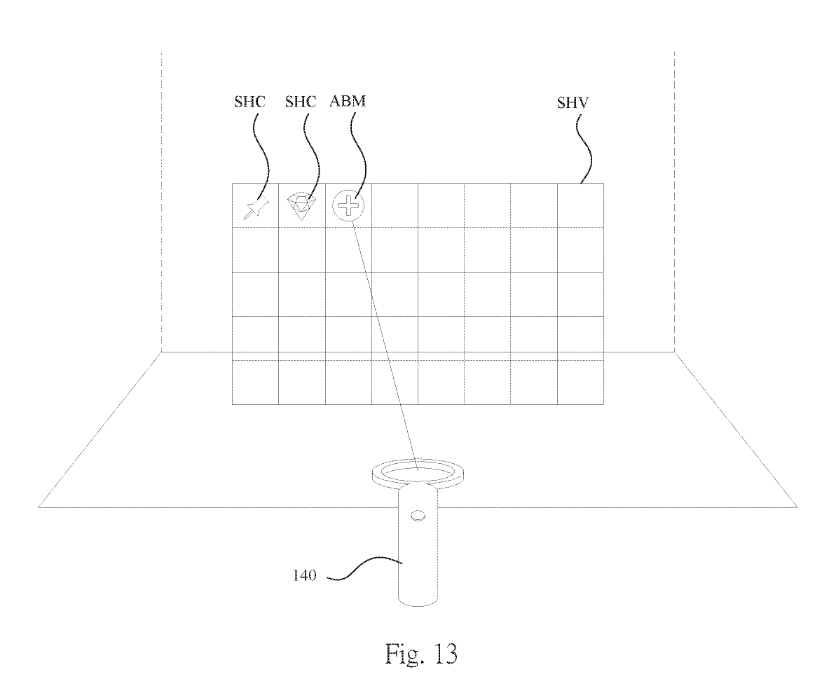

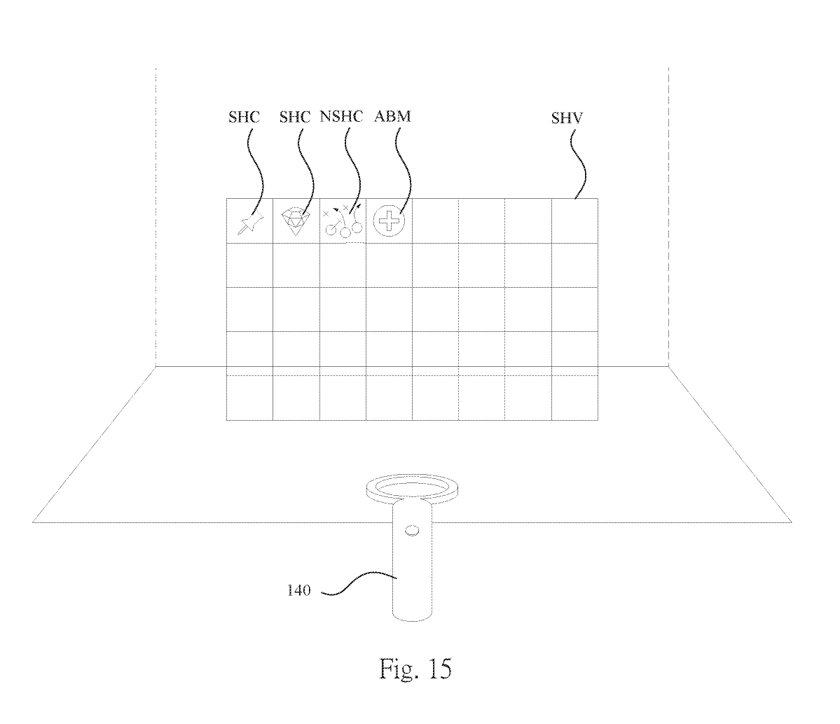

Reference is made to FIGS. 13-15. In one embodiment, the one or more processing components 110 can control the VR display device 130 to display a shortcut shelve SHV with one or more shortcuts SHC therein. In one embodiment, the shortcut shelve SHV may have an adding button ABM at the end of the row of the shortcuts SHC.

In one embodiment, the one or more processing components 110 can sense an actuating movement (e.g., a click or a selection) of the VR controller 140 on the adding button ABM. In response to the actuating movement of the VR controller 140 on the adding button ABM, the one or more processing components 110 can control the VR display device 130 to display an application picker APCK with applications APP (as illustrated in FIG. 14).

In one embodiment, the one or more processing components 110 can sense an actuating movement (e.g., a click or a selection) of the VR controller 140 on one of the applications in the application picker APCK. In response to the actuating movement of the VR controller 140 on the one of the applications in the application picker APCK, the one or more processing components 110 can control the VR display device 130 to stop displaying the application picker APCK, and display a new shortcut NSHC corresponding to the application selected through the application picker APCK in the shortcut shelve SHV.

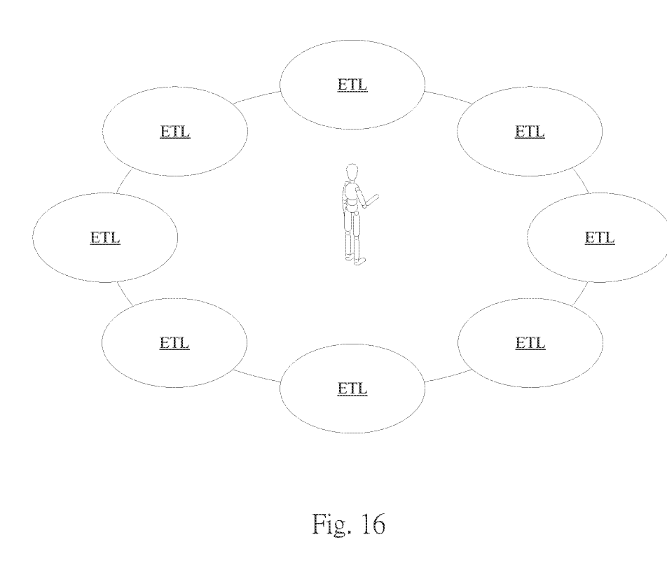

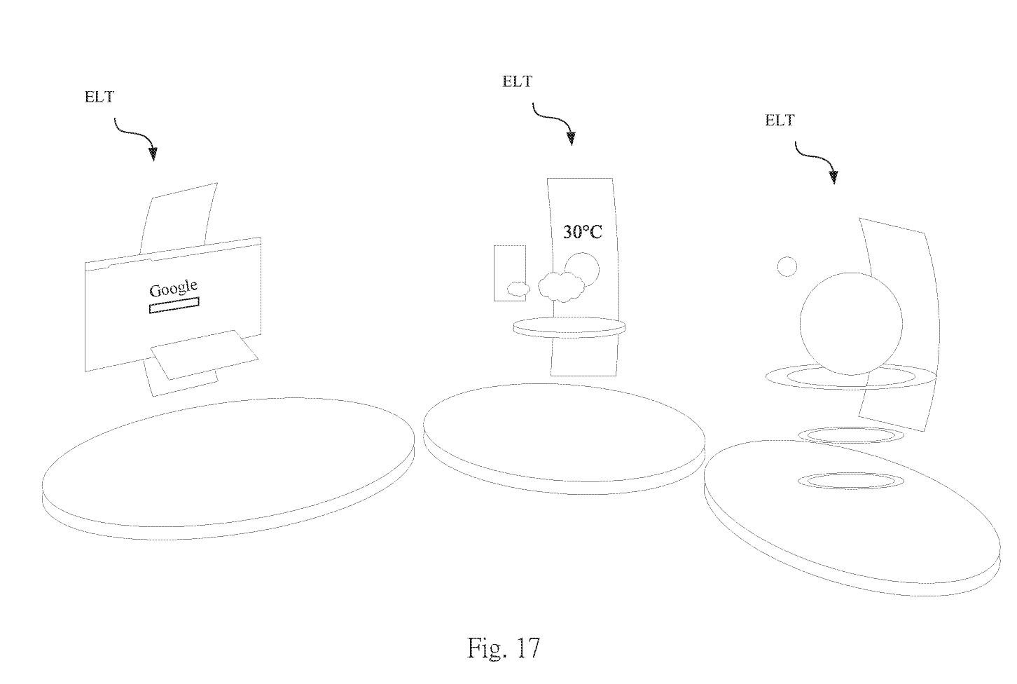

Reference is made to FIGS. 16-17. In one embodiment, the one or more processing components 110 can control the VR display device 130 to display multiple elements ELT around the VR character of the user in the VR environment, so that the user can turn around to interact with the elements ELT. In one embodiment, the elements ELT may form a ring, and the VR character of the user may be located at the center of the ring. In one embodiment, the elements ELT may be located within arm's reach of the VR character of the user.

In one embodiment, the elements ELT may include shortcuts to recent experiences, widgets that reveal the time or weather, browsers, social applications, and/or other navigational elements, but not limited in this regards.

In one embodiment, the one or more processing components 110 can sense an interacting movement (e.g., a drag movement, a click movement, or a hover movement) of the VR controller 140 corresponding to one of the elements ELT. In response to the interacting movement of the VR controller 140 corresponding to one of the elements ELT, the one or more processing components 110 can provide a corresponding reaction of the one of the elements ELT.

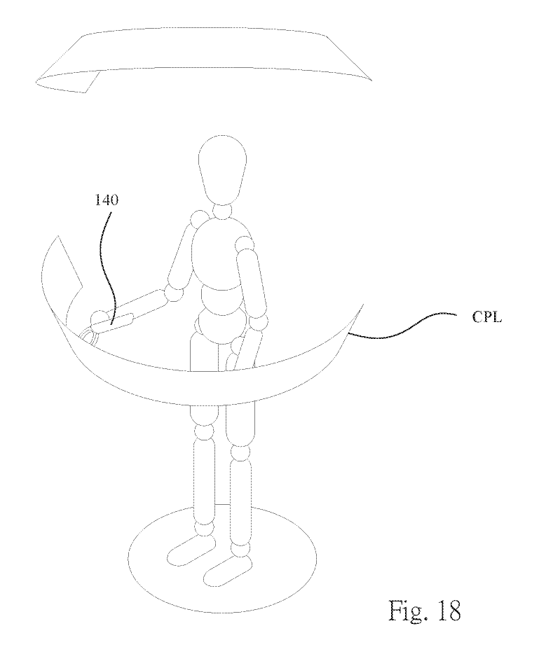

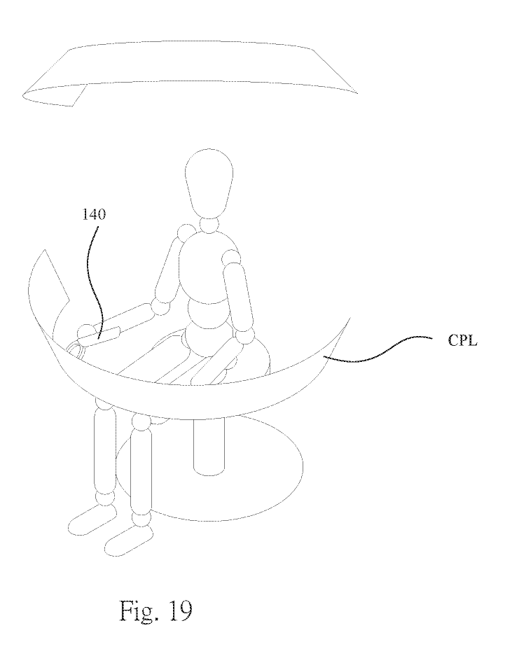

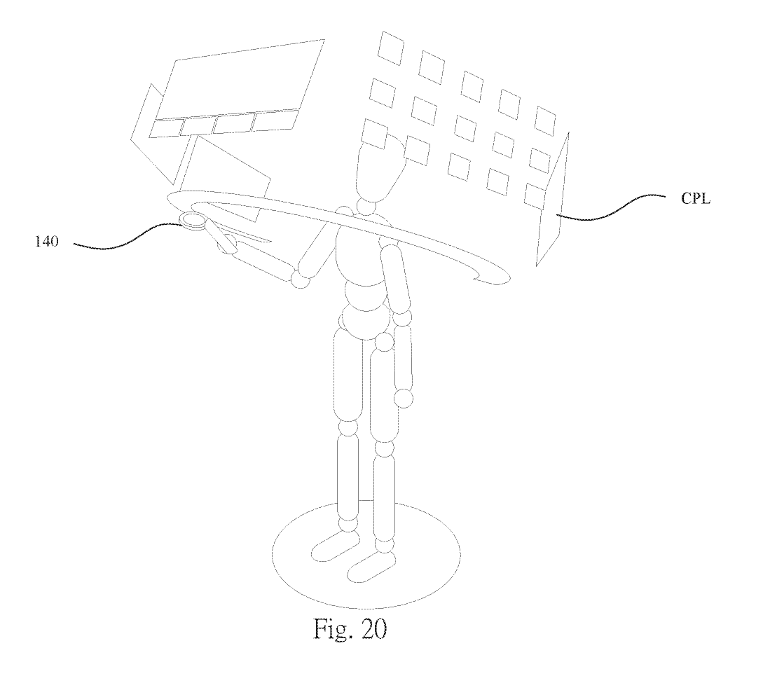

Reference is made to FIGS. 18-20. In one embodiment, the one or more processing components 110 can sense a position of the VR displaying device 130. The one or more processing components 110 can control the VR displaying device 130 to display an arc menu CPL corresponding to the position of the VR displaying device 130 in the VR environment. In one embodiment, the arc menu CPL may have a semicircular shape around the user. In one embodiment, the arc menu CPL is displayed around the VR character of the user.

In one embodiment, the position of the VR displaying device 130 may include a height of the VR displaying device 130 and/or a location of the VR displaying device 130.

In one embodiment, the arc menu CPL may be displayed around to the location of the VR displaying device 130. In one embodiment, the height of the arc menu CPL may corresponds to the height of the VR displaying device 130. In such a manner, the arc menu CPL can be displayed around the VR character of the user no matter the VR character of the user stands or seats.

In one embodiment, the one or more processing components 110 can also sense a tilt angle (e.g., a rotating angle) of the VR displaying device 130. The one or more processing components 110 can display an arc menu CPL corresponding to the position and the tilt angle of the VR displaying device 130 in the VR environment.

In one embodiment, a tilt angle of the arc menu CPL may corresponds to the tilt angle of the VR displaying device 130. In such a manner, even if the VR character of the user reclines, the arc menu CPL can be displayed around the VR character of the user.

Through such configurations, when the VR character of the user moves, the arc menu CPL can follows the VR character of the user at a consistent spatial relationship. For example, when the VR character of the user walks, the arc menu CPL moves correspondingly. However, when the VR character of the user rotates (e.g., along the Y-axis), the arc menu CPL will not rotate, so as to make the user access control to the left and right on the arc menu CPL.

In one embodiment, the one or more processing components 110 can sense an adjusting movement of the VR controller 140 corresponding to the arc menu CPL. In response to the adjusting movement of the VR controller 140 corresponding to the arc menu CPL, the one or more processing components 110 can adjust the position and/or the tilt angle of the arc menu CPL displayed by the VR displaying device 130. In one embodiment, the position and/or the tilt angle of the arc menu CPL can be customized by the user based on the position and/or the tilt angle of the VR controller 140 when activated or by manually moving and tilting the arc menu CPL through the VR controller 140.

In one embodiment, the arc menu CPL can be triggered through the VR controller 140, or when the user enters a certain physical zone or a certain VR zone.

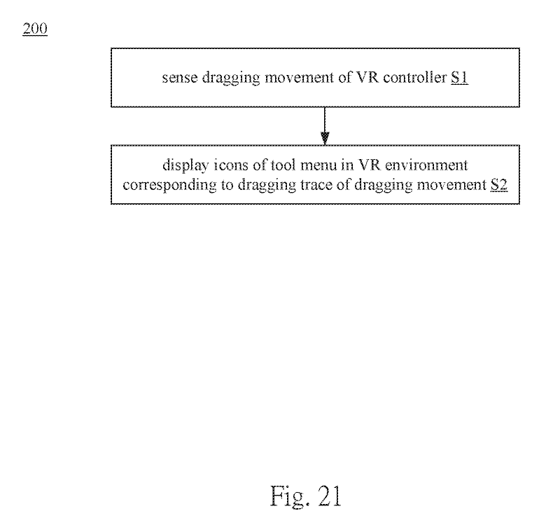

Details of the present disclosure are described in the paragraphs below with reference to a method for VR in FIG. 21. However, the present disclosure is not limited to the embodiment below.

It should be noted that the method can be applied to a VR processing device 100 having a structure that is the same as or similar to the structure of the VR processing device 100 shown in FIG. 1. To simplify the description below, the embodiment shown in FIG. 1 will be used as an example to describe the method according to an embodiment of the present disclosure. However, the present disclosure is not limited to application to the embodiment shown in FIG. 1.

It should be noted that, in some embodiments, the method may be implemented as a computer program. When the computer program is executed by a computer, an electronic device, or the one or more processing components 110 in FIG. 1, this executing device performs the method. The computer program can be stored in a non-transitory computer readable medium such as a ROM (read-only memory), a flash memory, a floppy disk, a hard disk, an optical disc, a flash disk, a flash drive, a tape, a database accessible from a network, or any storage medium with the same functionality that can be contemplated by persons of ordinary skill in the art to which this invention pertains.

In addition, it should be noted that in the operations of the following method, no particular sequence is required unless otherwise specified. Moreover, the following operations also may be performed simultaneously or the execution times thereof may at least partially overlap.

Furthermore, the operations of the following method may be added to, replaced, and/or eliminated as appropriate, in accordance with various embodiments of the present disclosure.

Reference is made to FIGS. 1 and 21. The method 200 includes the operations below.

In operation S1, the one or more processing components 110 sense a dragging movement of the VR controller 140 during a period that a trigger of the VR controller 140 is triggered.

In operation S2, the one or more processing components 110 control the VR display device 130 to display a plurality of icons of a tool menu in a VR environment corresponding to a dragging trace of the dragging movement of the VR controller 140.

Details of this method can be ascertained with reference to the paragraphs above, and a description in this regard will not be repeated herein.

Through the operations of one embodiment described above, displaying positions of the icons of the tool menu can be determined arbitrarily.

Although the present invention has been described in considerable detail with reference to certain embodiments thereof, other embodiments are possible. Therefore, the scope of the appended claims should not be limited to the description of the embodiments contained herein.

What is claimed is:

1. A method for virtual reality (VR) comprising:
sensing a dragging movement of a VR controller during a period that a trigger of the VR controller is triggered; and
displaying a plurality of icons of a tool menu in a VR environment corresponding to a dragging trace of the dragging movement of the VR controller.

2. The method as claimed in claim 1 further comprising:
displaying a shortcut creating button corresponding to one of the icons of the tool menu;
sensing an actuating movement of the VR controller on the shortcut creating button;
in response to the actuating movement on the shortcut creating button, displaying a 3D object or an application icon corresponding to the one of the icons of the tool menu in a VR space, wherein the 3D object or the application icon is moved corresponding to the VR controller;
sensing a pin movement of the VR controller corresponding to a place; and
in response to the pin movement, placing the 3D object or the application icon at the place in the VR space.

3. The method as claimed in claim 1, wherein under a condition that all of the icons of the tool menu are displayed during the period that the trigger of the VR controller is triggered, the icons of the tool menu are displayed substantially along with the dragging trace of the dragging movement of the VR controller.

4. The method as claimed in claim 1, wherein under a condition that the trigger of the VR controller stops being triggered before all of the icons of the tool menu are displayed, and an amount of the displayed icons are greater than a predetermined threshold, the rest icons are displayed according to a vector pointed from the second-to-last displayed icon to the last displayed icon.

5. The method as claimed in claim 1, wherein under a condition that the trigger of the VR controller stops being triggered before all of the icons of the tool menu are displayed, and an amount of the displayed icons are less than or equal to a predetermined threshold, one or multiple displayed icons are shrunk until invisible.

6. The method as claimed in claim 1 further comprising:
determining springback positions of the icons of the tool menu; and
animating the icons of the tool menu toward the springback positions;
wherein distances between original positions of the icons of the tool menu before the icons of the tool menu are animated toward the springback positions are greater than distances between the springback positions of the icons of the tool menu.

7. The method as claimed in claim 1 further comprising:
displaying a button of a shortcut action corresponding to one of the icons of the tool menu, wherein the button of the shortcut action allows a user to access a feature corresponding to the one of the icons of the tool menu without open a tool corresponding to the one of the icons of the tool menu.

8. The method as claimed in claim 1 further comprising:
sensing a position of a VR displaying device; and
displaying an arc menu corresponding to the position of the VR displaying device.

9. The method as claimed in claim 8 further comprising:
sensing an adjusting movement of the VR controller; and
adjusting a position of the arc menu corresponding to the adjusting movement of the VR controller.

10. The method as claimed in claim 1 further comprising:
sensing an actuation of an add icon of the icons of the tool menu;
displaying an item picker illustrating a plurality of items;
sensing an actuation of one of the items in the item picker; and
adding a shortcut of the one of the items into the tool menu to serve as a new icon.

11. A virtual reality (VR) device comprising:
one or more processing components;
memory electrically connected to the one or more processing components; and
one or more programs, wherein the one or more programs are stored in the memory and configured to be executed by the one or more processing components, the one or more programs comprising instructions for:
sensing a dragging movement of a VR controller during a period that a trigger of the VR controller is triggered; and
controlling a VR display device to display a plurality of icons of a tool menu in a VR environment corresponding to a dragging trace of the dragging movement of the VR controller.

12. The VR device as claimed in claim 11 further comprising instructions for:
controlling the VR display device to display a shortcut creating button corresponding to one of the icons of the tool menu;
sensing an actuating movement of the VR controller on the shortcut creating button;
in response to the actuating movement on the shortcut creating button, displaying a 3D object or an application icon corresponding to the one of the icons of the tool menu in a VR space, wherein the 3D object or the application icon is moved corresponding to the VR controller;
sensing a pin movement of the VR controller corresponding to a place; and
in response to the pin movement, placing the 3D object or the application icon at the place in the VR space.

13. The VR device as claimed in claim 11, wherein under a condition that all of the icons of the tool menu are displayed during the period that the trigger of the VR controller is triggered, the icons of the tool menu are displayed substantially along with the dragging trace of the dragging movement of the VR controller.

14. The VR device as claimed in claim 11, wherein under a condition that the trigger of the VR controller stops being triggered before all of the icons of the tool menu are displayed, and an amount of the displayed icons are greater than a predetermined threshold, the rest icons are displayed according to a vector pointed from the second-to-last displayed icon to the last displayed icon.

15. The VR device as claimed in claim 11, wherein under a condition that the trigger of the VR controller stops being triggered before all of the icons of the tool menu are displayed, and an amount of the displayed icons are less than or equal to a predetermined threshold, one or multiple displayed icons are shrunk until invisible.

16. The VR device as claimed in claim 11 further comprising instructions for:
determining springback positions of the icons of the tool menu; and
animating the icons of the tool menu toward the springback positions;
wherein distances between original positions of the icons of the tool menu before the icons of the tool menu are animated toward the springback positions are greater than distances between the springback positions of the icons of the tool menu.

17. The VR device as claimed in claim 11 further comprising instructions for:
controlling the VR display device to display a button of a shortcut action corresponding to one of the icons of the tool menu, wherein the button of the shortcut action allows a user to access a feature corresponding to the one of the icons of the tool menu without open a tool corresponding to the one of the icons of the tool menu.

18. The VR device as claimed in claim 11 further comprising instructions for:
sensing a position of a VR displaying device; and
controlling the VR display device to display an arc menu corresponding to the position of the VR displaying device.

19. The VR device as claimed in claim 18 further comprising instructions for:
sensing an adjusting movement of the VR controller; and
adjusting a position of the arc menu corresponding to the adjusting movement of the VR controller.

20. The VR device as claimed in claim 18 further comprising instructions for:
sensing an actuation of an add icon of the icons of the tool menu;
controlling the VR display device to display an item picker illustrating a plurality of items;
sensing an actuation of one of the items in the item picker; and
adding a shortcut of the one of the items into the tool menu to serve as a new icon.
